(19) United States
(12) Patent Application Publication
(10) Pub. No.: US 2017/0033335 A1
(43) Pub. Date: Feb. 2, 2017

(54) MOBILE DEVICE

(71) Applicant: Sharp Kabushiki Kaisha, Sakai City, Osaka (JP)

(72) Inventors: Yoshihisa KOJIMA, Sakai City (JP); Hirofumi TANAKA, Sakai City (JP)

(21) Appl. No.: 15/303,239

(22) PCT Filed: Apr. 28, 2015
(86) PCT No.: PCT/JP2015/002280

§ 371 Date: Oct. 11, 2016

(30) Foreign Application Priority Data
Apr. 28, 2014 (JP) 2014-093016

(51) Int. Cl. H01M 2/10; H04B 1/3883

(52) U.S. Cl. CPC H01M 2/1066; H04B 1/3883; H01M 2220/30; H01M 10/0525

(57) ABSTRACT

A tearable low adhesive sheet (29) is attached to a battery pack (19). This low adhesive sheet (29) is bonded with a double-sided adhesive tape (31) to a bottom face (17a) of a battery accommodating part (17) shaped into a recess and provided to a front cabinet (7) included in a casing (3), so that the battery pack (19) is secured to the battery accommodating part (17).

### TECHNICAL FIELD

The present disclosure relates to a mobile device including a built-in battery pack.

### BACKGROUND ART

Recently, battery packs including lithium-ion polymer batteries are becoming a common replacement for those including lithium-ion batteries for use in such mobile devices as cellular phones and tablets, since the lithium-ion polymer batteries have such satisfactory characteristics as high capacity, high voltage, and lightweight.

A lithium-ion battery uses an electrolyte solution as it is in the form of liquid. Hence, packaging and forming the lithium-ion battery is difficult, and thick and hard container would be required as an exterior material to cover the battery. In contrast, a lithium-ion polymer battery uses a gelled electrolyte solution in a quasi-liquid state, providing the battery with such advantages as keeping the battery from liquid spill, and allowing the battery to be packaged and formed relatively easily. Furthermore, the lithium-ion polymer battery uses a laminated pouch as an exterior material, contributing to downsizing the battery pack.

A battery pack using this lithium-ion polymer battery may have the above advantages; however, the battery pack also has a disadvantage that a dimension tolerance of the battery pack is large since the exterior material is laminated. Thus, when the battery is charged, the contour of the battery pack expands due to a chemical reaction of elements included in the battery. Moreover, the exterior material of such a battery pack is soft, reducing the stiffness of the battery pack. This makes it difficult to use, for example, an engagement hook to secure the battery pack to the casing of a mobile device. The battery pack might develop short circuit therein when folded or receiving a strong impact. Thus, with a double-sided adhesive tape, the battery pack is directly attached, and secured, to the casing and a circuit board in a limited space within the mobile device.

Patent Document 1 discloses a battery fixing device. When a battery pack, attached to a casing with a double-sided adhesive tape as described above, is removed from the casing, the battery fixing device keeps the battery pack from being deformed and damaged by stress, imposed on the battery pack, when the battery pack is removed.

This battery fixing device includes a cover accommodating the battery pack therein. The cover is bonded to the casing with an adhesive agent. Moreover, the cover includes: two rows of multiple through holes linearly arranged in parallel with each other; and a connector between the rows of the through holes. In the battery fixing device, the cover may be opened when the connecter is peeled off the cover along the rows of the multiple through holes, and separated from the cover. From the opened cover, the battery pack may be taken out without being damaged.

### CITATION LIST

### Patent Document

PATENT DOCUMENT 1: Japanese Unexamined Patent Publication No. 2013-89595

### SUMMARY OF THE INVENTION

### Technical Problem

Using the battery fixing device disclosed in PATEND DOCUMENT 1 may alleviate stress on the battery pack when the battery pack is taken out of the casing while the device is being disassembled to be recycled or repaired. However, if the size of the battery pack is small in relation to a space in the cover for accommodating the battery pack even though the battery pack is within a range of the dimension tolerance, a gap is left between the battery pack and the cover such that the battery pack rattles in the casing. This is because the battery pack is not bonded to the cover with, for example, an adhesive agent. As a result, when the mobile device is for example dropped, the battery pack could receive great stress caused by the impact of the drop and be damaged.

The present invention is conceived in view of the above problems and intends to alleviate stress on a battery pack due to an impact caused, for example, when a mobile device is dropped, and to allow the battery pack to be removable without being damaged.

### Solution to the Problem

In the present invention, a tearable low adhesive sheet is attached to a battery pack. The battery pack is bonded to a casing via this low adhesive sheet.

Specifically, the present invention is directed to a mobile device having the casing accommodating the battery pack. The mobile device includes features bellow.

The mobile device of the present invention includes a low adhesive sheet having an adhesive face to be attached to the battery pack so that the low adhesive sheet is wrapped around the battery pack, the adhesive face having low adhesiveness. Here, the term “low adhesiveness” means a degree of adhesiveness allowing the battery pack to be held without being easily displaced, and allowing the low adhesive sheet to be easily peeled off from the battery pack without significantly deforming the battery pack. Then, in the present invention, the battery pack is secured to the casing with the low adhesive sheet bonded to the casing with an adhesive material.

Thanks to the above configuration, the low adhesive sheet is attached to the battery pack, and the battery pack is secured to the casing through the low adhesive sheet, so that the battery pack is held in the casing by the low adhesive sheet. Holding the battery pack may alleviate stress, on the battery pack, due to the impact occurring when the cellular phone is, for example, dropped. Furthermore, when the device is disassembled to be recycled or repaired, the configuration allows the battery pack to be removed either from the casing together with the low adhesive sheet or from the low adhesive sheet to be taken out of the casing. When the battery pack is removed with the former technique, the low adhesive sheet is allowed to be torn. After the battery pack is removed from the casing, the low adhesive sheet may be peeled off the battery pack. Because of relatively low adhesiveness to the battery pack, this low adhesive sheet may be easily peeled off the battery pack without excessive stress on the battery pack.

### ADVANTAGES OF THE INVENTION

The present invention may alleviate stress on a battery pack due to an impact caused, for example, when a mobile device is dropped, and allow the battery pack to be removed without being damaged.

### BRIEF DESCRIPTION OF THE DRAWINGS

FIG. 1 is a perspective view seen from a front of a cellular phone according to a first embodiment of the present invention.

FIG. 2 is an exploded perspective view of the cellular phone according to the first embodiment of the present invention.

FIG. 3 is a rear view of the cellular phone according to the first embodiment of the present invention, the cellular phone accommodating a control circuit board of a front cabinet constituting a casing of the cellular phone.

FIG. 4 is a cross-sectional view of the cellular phone seen along lines IV-IV in FIG. 3.

FIG. 5A is a perspective view illustrating a battery pack with a low adhesive sheet according to the first embodiment of the present invention, the low adhesive sheet being attached to the battery pack. FIG. 5B is a perspective view illustrating how the low adhesive sheet is attached to the battery pack.

FIG. 6 is a cross-sectional view illustrating how to remove the battery pack from the front cabinet of the cellular phone according to the first embodiment of the present invention.

FIG. 7A is a perspective view illustrating a battery pack provided with a pull-off tab according to a second embodiment of the present invention. FIG. 7B is a perspective view illustrating how to attach the pull-off tab to the battery pack together with a low adhesive sheet.

FIG. 8 is a cross-sectional view illustrating how to remove the battery pack from a front cabinet of the cellular phone according to the second embodiment of the present invention.

FIG. 9A is a plan view of a low adhesive sheet according to a third embodiment of the present invention. FIG. 9B is a perspective view illustrating a battery pack with the low adhesive sheet attached thereto. FIG. 9C is a perspective view illustrating how the low adhesive sheet is attached to the battery pack.

### DESCRIPTION OF EMBODIMENTS

Described below in detail are embodiments of the present invention, with reference to the drawings. Note that the embodiments below are essentially beneficial examples, and are not intended to limit the scope of the present invention, of the application of the present invention, or of the use of the present invention.

In the embodiments, for the purpose of explanation, the front-face side of the display panel of a cellular phone is called “front”, and the rear-face side “rear.” The upside of the display panel of the cellular phone in the vertical direction is called “upside”, and the downside “downside.” When the display panel is viewed from the front, the left side of the display panel in the right-left direction is called “left”, and the right-hand side “right.”

### First Embodiment of the Invention

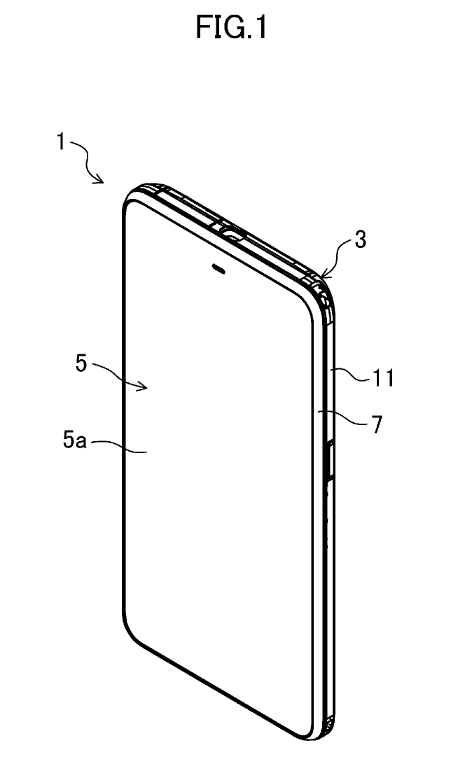

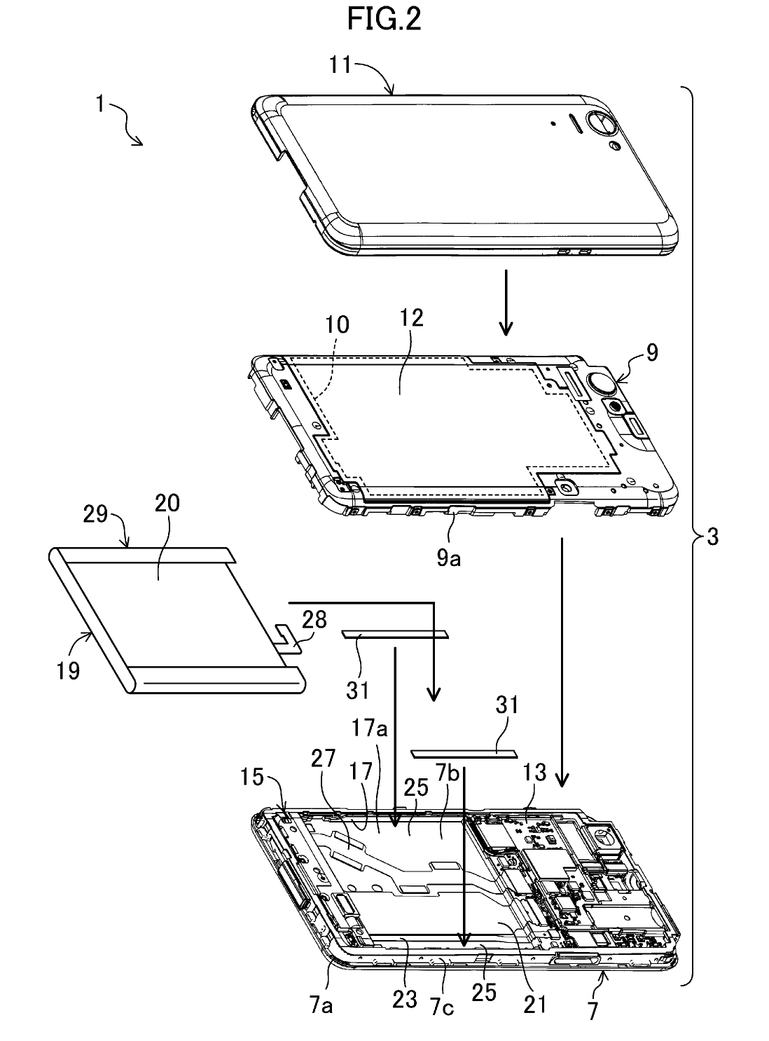

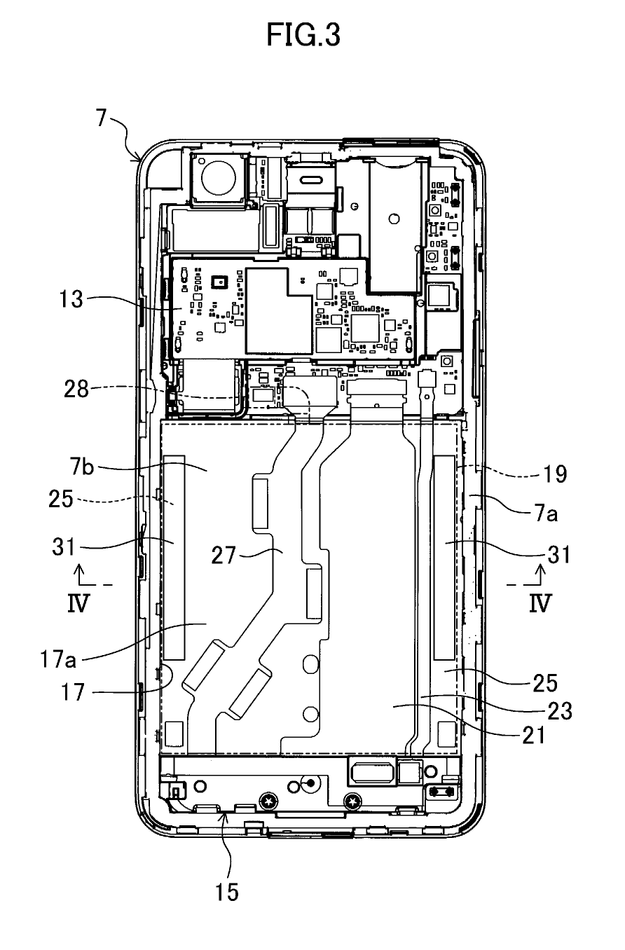

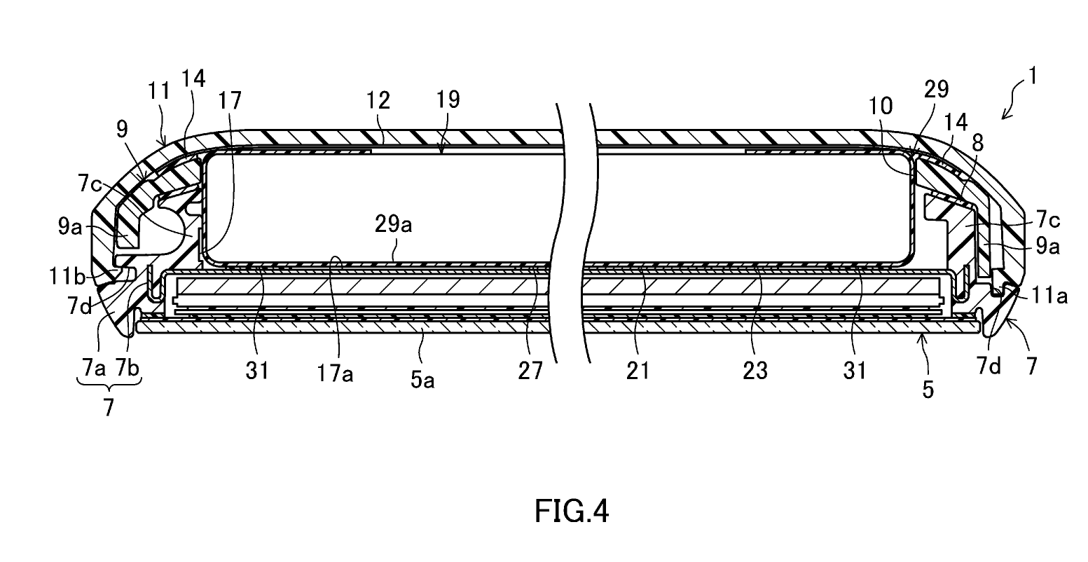

FIG. 1 is a perspective view illustrating a cellular phone 1, according to this first embodiment, viewed from the front. FIG. 2 is an exploded perspective view of this cellular phone 1. FIG. 3 is a rear view of the cellular phone 1 accommodating a control circuit board 13 of a front cabinet 7. The front cabinet 7 constitutes a casing 3 of the cellular phone 1. Furthermore, FIG. 4 is a cross-sectional view of the cellular phone 1 seen along lines IV-IV in FIG. 3.

As illustrated in FIGS. 1 and 2, the cellular phone 1 is a mobile device called a “single-piece smartphone”. The cellular phone 1 has the casing 3 shaped into a flat and general rectangle when viewed from the front. The casing 3 includes multiple electronics parts such as a speaker, a microphone, a camera unit, a card connector, a control circuit board 13, and a battery pack 19. The control circuit board 13 controls operations of the speaker, the microphone, the camera unit, and the card connector.

The casing 3 includes: a front cabinet 7 accommodating, in the front, a display device 5 including a display panel 5a displaying an image; a back cabinet 9 attached to the back of this front cabinet 7; and a rear cover 11 covering the back of this back cabinet 9. The display panel 5a is provided with a touch panel, and constitutes a user interface of the cellular phone 1.

As illustrated in FIGS. 2 and 4, the front cabinet 7 includes a frame 7a made of resin and having a substantially rectangular shape. The front cabinet 7 has a metal plate 7b insert-molded to cover an inner opening of this frame 7a. The metal plate is made of, for example, a stainless steel plate, and acts as a stiffening member. The frame 7a of this front cabinet 7 is provided with an inner wall 7c protruding backward in the form of a wall.

The back cabinet 9, a molded product made of resin, has a contour corresponding to the front cabinet 7 in a planar view. This back cabinet 9 has an outer periphery edge provided with an outer wall 9a protruding forward in the form of a wall. This outer wall 9a extends outside, and overlaps with, the inner wall 7c of the front cabinet 7. An adhesive material 8, including a double-sided adhesive tape and an adhesive agent, joins an inner portion along a base end of the outer wall 9a of the back cabinet 9 and an edge of the inner wall 7c of the front cabinet 7.

Instead of being joined with the adhesive material 8, the front cabinet 7 and the back cabinet 9 may be, for example, screwed together. Moreover, the front cabinet 7 and the back cabinet 9 may be joined together by a combination of bonding with adhesive agent 8 and fastening with, for example, a screw. In this back cabinet 9, there is a part including a portion to be described below corresponding to the battery pack 19. The part includes an opening 10 having a large area. In order to cover the opening 10, an outer periphery edge of a waterproof sheet 12 is attached to a periphery edge of the opening 10, using an adhesive material 14 including a double-sided adhesive tape and an adhesive agent.

The rear cover 11, a molded product made of resin and shaped into a shallow and substantially rectangular pan, has a contour corresponding to the front cabinet 7 in a planar view. This rear cover 11 has an outer periphery edge provided with multiple locking hooks 11a and 11b protruding either forward or inward (see FIG. 4). The rear cover 11 is coupled to the front cabinet 7 with these locking hooks 11a and 11b engaging with an engaging hole 7d provided to the front cabinet 7. The back cabinet 9 is covered with the rear cover 11, and accommodated between the front cabinet 7 and the rear cover 11.

There is a space in back of the front cabinet 7 and between the front cabinet 7 and the back cabinet 9. As illustrated in FIGS. 2 and 3, the space accommodates in its upper half the control circuit board 13, and in its lower half an external connection unit 15 connected to an external power source. In the front cabinet 7, there is a portion located between the control circuit board 13 and the external connection unit 15, and behind the display panel 5a. The portion is provided with a battery accommodating part 17 recessed toward the front and having a substantially rectangular shape. This battery accommodating part 17 accommodates the battery pack 19 shaped in a flat and substantially rectangular plate.

The battery accommodating part 17 has a bottom face 17a—a battery pack installation face 17a on which the battery pack 19 is placed—including a portion of the metal plate 7b of the front cabinet 7. At the left of the battery pack installation face 17a in this battery accommodating part 17, as illustrated in FIG. 3, a panel flexible printed circuit (FPC) 21 and a light FPC 23 vertically extend across the battery accommodating part 17. The panel FPC 21 connects the display panel 5a and the control circuit board 13. The light FPC 23 connects a backlight included in the display device 5, and the control circuit board 13.

In this embodiment, the panel FPC 21 is placed to the right and the light FPC 23 is placed to the left. The light FPC 23 is spaced away toward the right from a left edge, of the battery pack installation face 17a in the battery accommodating part 17. In FIG. 3, the light FPC 23 is spaced away from a right edge of the battery pack installation face 17a toward the left. Such spacing allows a bonding surface 25, to which a low adhesive sheet 29 described below is bonded, to be provided to a portion along a left edge of the battery pack installation face 17a so that the metal plate 7b of the front cabinet 7 is exposed from the panel FPC 21 and the light FPC 22.

Moreover, at the right of the battery pack installation face 17a, an external connection FPC 27 vertically extends across the battery accommodating part 17. The external connection FPC 27 connects the control circuit board 13 and the external connection unit 15. The external connection FPC 27 is spaced away from a right edge of the battery pack installation face 17a toward the left. In FIG. 3, the external connection FPC 27 is spaced away from a left edge of the battery pack installation face 17a toward a right side. Such spacing allows the bonding surface 25, to which the after-described low adhesive sheet 29 is bonded, to be provided to a portion along the right edge of the battery pack installation face 17a, so that the metal plate 7b of the front cabinet 7 is exposed from the external connection FPC 27.

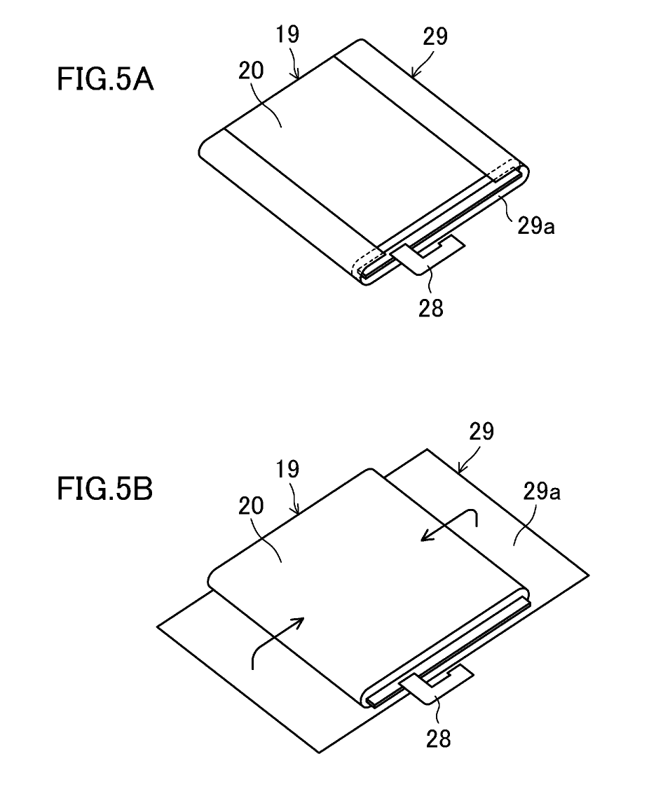

FIG. 5A is a perspective view illustrating the battery pack 19 with the low adhesive sheet 29 attached thereto. FIG. 5B is a perspective view illustrating how the low adhesive sheet 29 is attached to the battery pack 19. The battery pack 19 includes a lithium-ion polymer battery. The lithium-ion polymer battery uses a polymer electrolyte, which is made of an electrolyte solution mixed with a polymer so that the mixture is gelled. A battery element including this gelled polymer electrolyte, a positive electrode, and a negative electrode is encapsulated in a laminated pouch 20 which is a soft exterior material. The lithium-ion polymer battery is a type of battery called a “pouch battery” or a “laminated exterior battery” having low stiffness.

As illustrated in FIG. 5A, this battery pack 19 includes an FPC 28 for connecting the battery pack 19 to the control circuit board 13. Since this FPC 28 is connected to the control circuit board 13, the battery pack 19 is ready to supply power to the control circuit board 13, and accommodated in the battery accommodating part 17. As illustrated in FIG. 4, the display panel 5a is accommodated in the front cabinet 7, with a back of the display panel 5a facing the battery pack 19. The low adhesive sheet 29, which is soft, has one face entirely provided with an adhesive face 29a. The battery pack 19 is wrapped in the low adhesive sheet 29 with the adhesive face 29a attached to the battery pack 19.

The low adhesive sheet 29 includes a soft base material made of such non-flammable general-purpose plastic as polyethylene terephthalate (PET). In the preparation of the low adhesive sheet 29, one face of the base material is entirely coated with glue to form the adhesive face 29a. This low adhesive sheet 29 is transparent so that a user can see what is written on a battery label (not shown), as required by law even if the low adhesive sheet 29 covers the label.

The low adhesive sheet 29 is shaped into a substantial rectangular when spread. The low adhesive sheet 29 is approximately the same in vertical width as the battery pack 19. Moreover, when the low adhesive sheet 29 is wrapped around the battery pack 19, a length of the low adhesive sheet 29 in a direction of the wrapping is shorter than an outer perimeter of the battery pack 19 along its front face, rear face, right side face, and left side face.

The adhesive face 29a of the low adhesive sheet 29 has low adhesiveness to the degree that the adhesive face 29a may (i) hold the battery pack so that the battery pack 19 is not easily displaced, and (ii) be easily peeled off when the low adhesive sheet 29 is removed, without significantly deforming the laminated pouch 20 acting as an exterior material of the battery pack 19. Specifically, the glue used to form the adhesive face 29a has low adhesiveness of this degree.

A center of the low adhesive sheet 29 along the length is attached to a front face of the battery pack 19. Both sides of the low adhesive sheet 29 along the length are folded toward a rear face of the battery pack 19, and attached over the right and left side faces to the rear face of the battery pack 19. Both ends of the sides of the low adhesive sheet 29 along the length face each other in the right-left direction on the rear face of the battery pack 19.

Then, the low adhesive sheet 29 has a break in a direction of the wrapping around the battery pack 10, so that a portion of the battery pack 19 is left uncovered backward. Specifically, the low adhesive sheet 29 is attached only to a portion of a circumference of the battery pack 19 in the wrapping direction, and is not attached to the entire circumference in the wrapping direction. Such a feature reduces damage to the battery pack due to expansion caused when the battery pack 19 is charged. Described below are details of the feature.

When the battery pack 19 is charged, an electrode (e.g., the negative electrode) of the battery element changes in molecular structure, causing expansion of the electrode followed by expansion of a contour of the battery pack 19. When the battery pack in PATENT DOCUMENT 1 is sized not to have a gap between the battery pack itself and the cover, such an expansion of the contour of the battery pack presses the battery pack against the cover surrounding the circumference of the battery pack. Such pressure causes a deformation of the battery pack, such as a deflection, and the stress caused by the deformation could damage the battery pack.

In contrast, thanks to the above configuration, the low adhesive sheet 29 according to this embodiment allows the battery pack 19 to expand even if the contour of the battery pack 19 expands. When the battery pack 19 expands, such a feature may keep the battery pack 19 from such deformation as deflection, contributing to alleviation of the stress on the battery pack 19 caused by the deformation. The alleviation of the stress may reduce the damage, to the battery pack 19, due to the deformation caused when the battery pack 19 expands.

As illustrated in FIG. 5B, the center of the low adhesive sheet 29 is first attached to the front face of the battery pack 19. Then, both of ends of the low adhesive sheet 29 are folded toward, and attached to, the rear face of the battery pack 19. Thus, the entire low adhesive sheet 29 is attached to, and wrapped around, the battery pack 19.

The battery pack 19 is accommodated in the battery accommodating part 17, with the break of the low adhesive sheet 29—a portion of the battery pack 19 left uncovered with the low adhesive sheet 29—facing an opening (the rear) of the battery accommodating part 17, the opening being opposite the display panel 5a. Thus, the rear of the battery pack 19 is partially exposed from the low adhesive sheet 29 between both of the ends of the low adhesive sheet 29 in the length direction. The display panel 5a is placed in front of the battery pack 19. In the above configuration, the battery pack 19 mainly expands toward the break of the low adhesive sheet 29. Such a feature may reduce the risk that the display panel 5a is pressed from the rear by the expansion of the battery pack 19, contributing to reducing occurrence of such a defect as bleeding in the display panel 5a.

Then, as illustrated in FIGS. 2 and 4, the battery pack 19 is secured to the battery accommodating part 17, with this low adhesive sheet 29 bonded to the battery pack installation face 17a of the battery accommodating part 17 using a double-sided adhesive tape 31 which is easy to handle as an adhesive material. Each of double-sided adhesive tapes 31 is vertically strip-shaped, and attached to one of the bonding surfaces 25 on the right side and the left side of the battery pack installation face 17a, so that the double-sided adhesive tapes 31 do not overlap with FPCs 21, 23, and 27. Then, the right and left ends, of the low adhesive sheet 29, attached to the front face of the battery pack 19 are each attached to one of the bonding surfaces 25 of the battery pack installation face 17a with these double-sided adhesive tapes 31.

Hence, the battery pack 19 is attached to the battery pack installation face 17a of the battery accommodating part 17 via the low adhesive sheet 29, and held by the low adhesive sheet 29. Such a feature may alleviate the stress, on the battery pack 19, due to the impact caused when the cellular phone 1 is, for example, dropped.

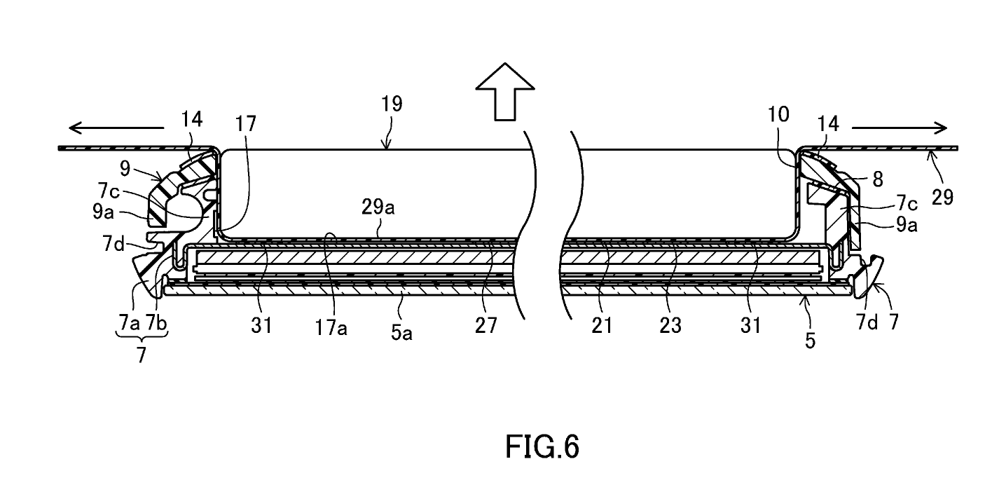

FIG. 6 is a cross-sectional view illustrating how to remove the battery pack 19 from the cellular phone 1. When the battery pack 19 is removed from the above-structured cellular phone 1, the rear cover 11 is first removed from the front cabinet 7, and next, the waterproof sheet 12 is removed from the back cabinet 9, such that the battery accommodating part 17 accommodating the battery pack 19 is exposed outside.

Then, as illustrated in FIG. 6, both of the ends of the low adhesive sheet 29 are peeled off the rear face of the battery pack 19, and pulled away from each other, so that the battery pack 19 is taken out of the battery accommodating part 17 together with the low adhesive sheet 29. Here, the low adhesive sheet 29 is allowed to be torn.

After that, the low adhesive sheet 29 is peeled off the battery pack 19. Because of relatively low adhesiveness to the battery pack 19, the low adhesive sheet 29 may be easily peeled off the battery pack 19 without excessive stress on the battery pack 19. Hence, the battery pack 19 may be removed from the cellular phone 1.

This first embodiment makes it possible to alleviate stresses, on the battery pack 19, caused by the impact when the cellular phone 1 is, for example, dropped, and by the expansion when the battery pack 19 is charged. In addition, the first embodiment allows a user to remove the battery pack 19 from the cellular phone 1 without inflicting damage to the battery pack 19. As a result, the battery pack 19 may be reused after repair, bringing great benefits in terms of low repair costs and resource protection.

### Second Embodiment of the Invention

The cellular phone 1 according to a second embodiment is different from that according to the first embodiment in that a pull-off tab 33 is provided to the battery pack 19. Note that, the embodiments below are the same in the configuration as the first embodiment regarding the cellular phone 1, except a configuration of the low adhesive sheet 29, and the pull-off tab 33 additionally provided. Thus, the same configurations are to be referred to those in the first embodiment with reference to FIGS. 1 to 6, and the details thereof shall be omitted.

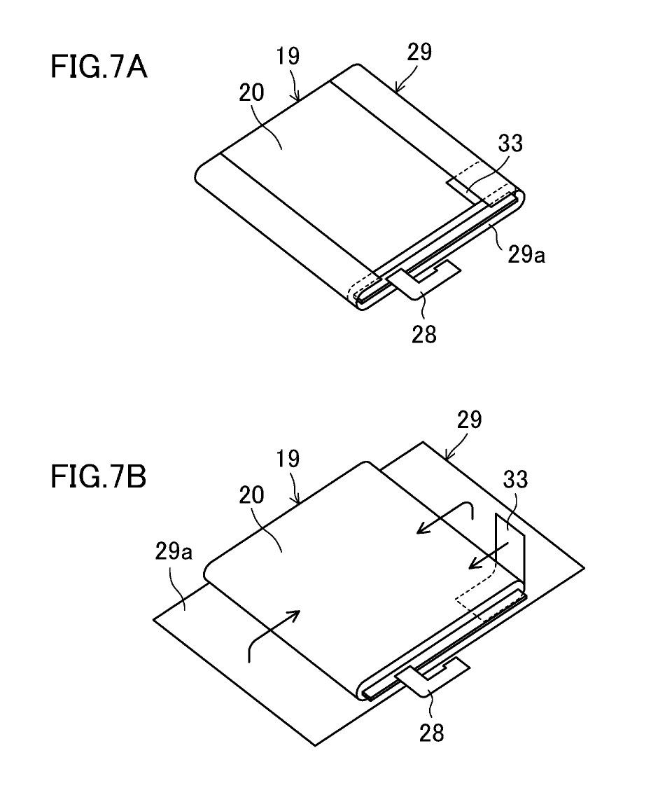

FIG. 7A is a perspective view illustrating the battery pack 19 provided with the pull-off tab 33 according to the second embodiment. FIG. 7B is a perspective view illustrating how to attach the pull-off tab 33 to the battery pack 19 together with the low adhesive sheet 29. As illustrated in FIG. 7A, the pull-off tab 33 is provided between the battery pack 19 and the low adhesive sheet 29 in the second embodiment. The pull-off tab 33 is rectangular and strip-shaped, and used for removing the battery pack 19 from the battery accommodating part 17.

The pull-off tab 33 partially covers either a right side-face or a left side-face (the right side-face in an example illustrated in FIG. 7A) of the battery pack 19. The pull-off tab 33 is provided over the front face to the rear face of the battery pack 19, and sandwiched between the battery pack 19 and the low adhesive sheet 29. With a double-sided adhesive tape and an adhesive agent, an end of the pull-off tab 33 is attached to a front face, of the battery pack 19, opposite the battery pack installation face 17a through the low adhesive sheet 29. Moreover, another end of the pull-off tab 33 extends to the break, of the low adhesive sheet 29, which uncovers the battery pack 19, and is exposed from the low adhesive sheet 29 behind the battery pack 19.

This pull-off tab 33 is provided to the battery pack 19 as illustrated in FIG. 7B. First, the end of the pull-off tab 33 is attached to the front face of the battery pack 19. After that, when the low adhesive sheet 29 is attached to the battery pack 19, the other end of the pull-off tab 33 is folded toward the rear face of the battery pack 19 together with the low adhesive sheet 29. Then, the other end is partially covered with the folded low adhesive sheet 29, and attached to the battery pack 19.

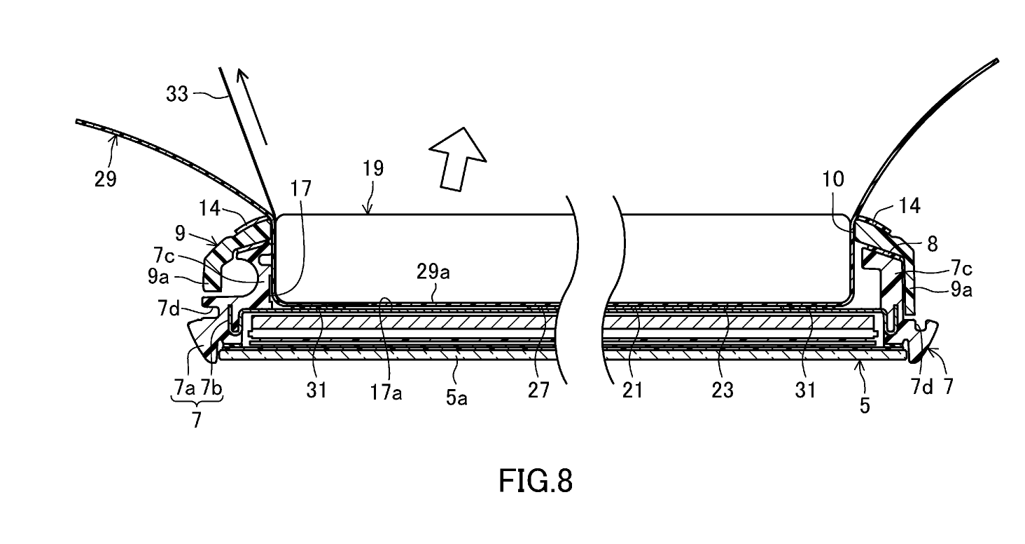

FIG. 8 is a cross-sectional view illustrating how to remove the battery pack 19 from the cellular phone 1. When the battery pack 19 is removed from the cellular phone 1, first, similar to the first embodiment, the battery accommodating part 17 accommodating the battery pack 19 is exposed outside. Next, as illustrated in FIG. 8, both of the ends of the low adhesive sheet 29 are peeled off the rear face of the battery pack 19. After that, a portion, of the pull-off tab 33, behind the battery pack 19 is pulled backward such that the battery pack 19 is removed from the low adhesive sheet 29, and taken out of the battery accommodating part 17. Hence, the battery pack 19 may be removed from the cellular phone 1.

This second embodiment allows a user to easily take the battery pack 19 out of the battery accommodating part 17 without damaging the battery pack 19 by simply pulling the pull-off tab 33 provided to the battery pack 19, contributing to easy removal of the battery pack 19.

### Third Embodiment of the Invention

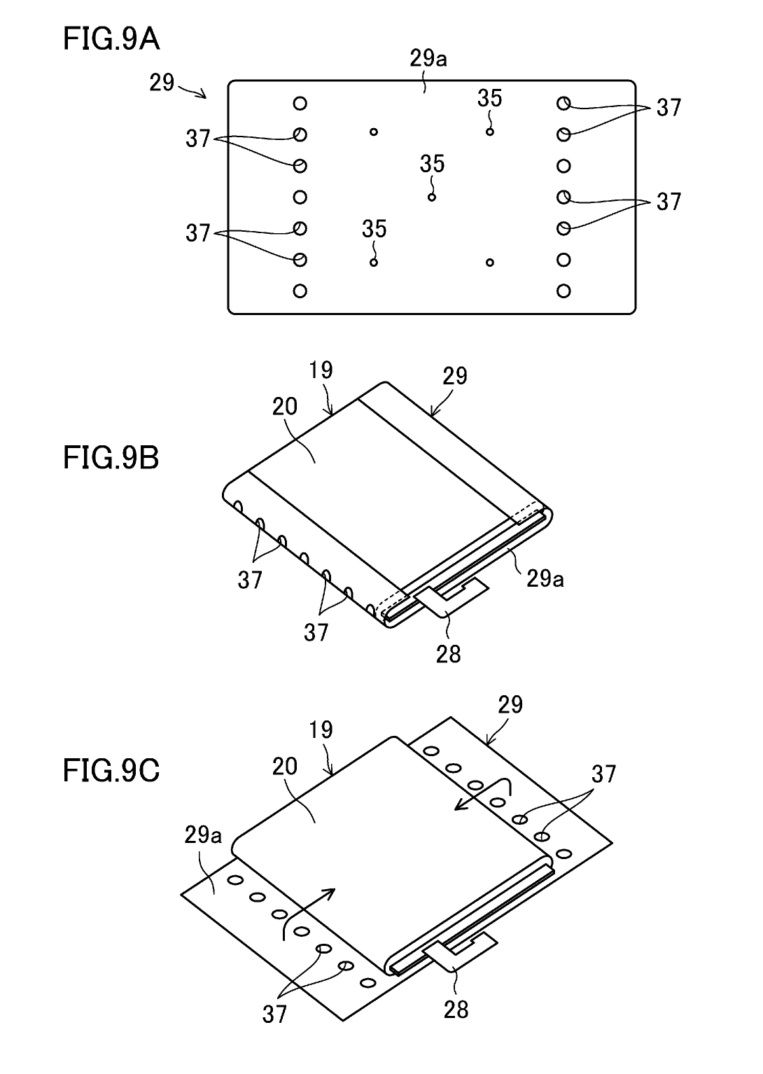

The cellular phone 1 according to a third embodiment is different in the configuration of the low adhesive sheet 29 attached to the battery pack 19 from the cellular phone 1 according to the first embodiment. FIG. 9A is a plan view of the low adhesive sheet 29 according to this third embodiment. FIG. 9B is a perspective view illustrating the battery pack 19 with the low adhesive sheet 29 attached thereto. FIG. 9C is a perspective view illustrating how the low adhesive sheet 29 is attached to the battery pack 19.

The low adhesive sheet 29 in this third embodiment has multiple through holes 35 and 37. Specifically, a portion of the low adhesive sheet 29, to be attached to the front face of the battery pack 19, has multiple first through holes 35 (five first through holes in an example in FIG. 9A) spaced apart from each other. These first through holes 35 are formed to let air, trapped between the adhesive face 29a of the low adhesive sheet 29 and the battery pack 19, escape outside when the low adhesive sheet 29 is attached to the battery pack 19.

Moreover, a portion of the low adhesive sheet 29, folded along a contour of the battery pack 19, has vertically-aligned multiple second through holes 37 in a single line (seven second through holes illustrated in an example in FIG. 9A). Here, the portion includes portions each attached to one of a right side-face and a left side-face of the battery pack 19. Formed larger in diameter than the first through holes 35, these second through holes 37 are to reduce resilience (elasticity) of the folded portion of the low adhesive sheet 29, in addition to letting the air, trapped between the low adhesive sheet 29 and the battery pack 19, escape outside.

As illustrated in FIG. 9C, the low adhesive sheet 29 is wrapped around, and attached to, the battery pack 19 in accordance with a sequence similar to that in the first embodiment.

When the low adhesive sheet 29 is attached to the battery pack 19, the third embodiment makes it possible to let the air, trapped between the low adhesive sheet 29 and the battery pack 19, escape from the first through holes 35 and the second through holes 37. Such a feature enables reducing air bubbles formed between the low adhesive sheet 29 and the battery pack 19, contributing to curbing a decrease, by the air bubbles, in the force of the low adhesive sheet 29 to hold the battery pack 19.

Furthermore, in the third embodiment, the second through holes 37 reduce the resilience of the folded portion of the low adhesive sheet 29. Hence, both of the ends, along the length of the low adhesive sheet 29, are less likely to come off by the resilience of the low adhesive sheet 29 because of their low adhesiveness. Such features contribute to curbing a decrease in the force of the low adhesive sheet 29 to hold the battery pack 19 because of the coming-off of the low adhesive sheet 29.

Note that the first to third embodiments describe, showing examples, that the low adhesive sheet 29 has a break in the direction of the wrapping around the battery pack 19, so that a portion of the battery pack 19 is left uncovered backward. Instead, the low adhesive sheet 29 may be wrapped around the entire circumference; that is, the front face, the rear face, the right face, and the left face of the battery pack 19. Then, both the ends of the low adhesive sheet 29 may overlap with each other on an outer periphery face of the battery pack 19. Here, in view of allowing the expansion of the battery pack 19, beneficially, an adhesive face is not provided to at least an outer one of the ends of the low adhesive sheet 29, and the overlapping portions of the low adhesive sheet 29 are not bonded with each other.

In the first to third first embodiments, the battery pack 19 is a battery pack including a lithium-ion polymer battery; however, the battery pack 19 may be a battery pack including such a battery as a pouch battery (laminated exterior battery), other than the lithium-ion polymer battery. For example, the battery pack 19 may use a lithium-ion battery having a battery element containing, instead of a gelled electrolyte, an electrolyte solution encapsulated in the laminated pouch 20.

In the first to third embodiments, the low adhesive sheet 29 attached to the battery pack 19 is attached, with the double-sided adhesive tape 31, to the battery pack installation face 17a of the battery accommodating part 17. Instead, the low adhesive sheet 29 may be bonded with an adhesive agent to the battery pack installation face 17a.

The first to third first embodiments describe with examples that the adhesive face 29a is provided to, but not limited to, an entire face of the low adhesive sheet 29. The adhesive face 29a may also be partially provided to a face of the low adhesive sheet 29. The adhesive face 29a of the low adhesive sheet 29 is formed of, but not limited to, glue applied to the low adhesive sheet 29. The adhesive face 29a may also be a double-sided adhesive tape attached to one face of a base material.

The third embodiment describes with an example that the multiple second through holes 37 are formed on the low adhesive sheet 29. Instead of the multiple second through holes 37, one second through hole 37, shaped into a vertically extending slit, may be provided to a portion of the low adhesive sheet 29 folded along the contour of the battery pack 19. Here, the portion includes portions each attached to one of the right side-face and the left side-face of the battery pack 19.

In the first to third embodiments, the cellular phone 1 is exemplified as a mobile device according to the present invention. Other than to a cellular phone, the present invention may be applied to such mobile devices as a personal handy-phone system (PHS), a personal digital assistant (PDA), a personal computer, a mobile tool, an electronic dictionary, a tablet terminal, and a game device.

### DESCRIPTION OF REFERENCE CHARACTERS

1 Cellular Phone (Mobile Device)

3 Casing

5 Display Device

5a Display Panel

7 Front Cabinet

7a Frame

7b Metal Plate

7c Inner Wall

7d Engaging Hole

8 Adhesive Material

9 Back Cabinet

9a Outer Wall

10 Opening

11 Rear Cover

11a Locking Hook

11b Locking Hook

12 Waterproof Sheet

13 Control Circuit Board

14 Adhesive Material

15 External Connection Unit

17 Battery Accommodating Part

17a Battery Pack Installation Face

19 Battery Pack

21 Panel FPC

23 Light FPC

25 Bonding Surface

27 External Connection FPC

28 Battery Pack FPC

29 Low Adhesive Sheet

31 Double-Sided Adhesive Tape

33 Pull-off tab

35 First Through Hole

37 Second Through Hole

1. A mobile device including a casing accommodating a battery pack, the mobile device comprising:
a low adhesive sheet including an adhesive face to be attached to the battery pack so that the low adhesive sheet is wrapped around the battery pack, the adhesive face having low adhesiveness; wherein
the battery pack is secured to the casing with the low adhesive sheet bonded to the casing with an adhesive material.

2. The mobile device of claim 1, wherein
the low adhesive sheet has a break in a direction of the wrapping around the battery pack, so that a portion of the battery pack is left uncovered.

3. The mobile device of claim 1, wherein
the low adhesive sheet has a plurality of through holes on a portion provided with the adhesive face and a portion folded along a contour of the battery pack.

4. The mobile device of claim 2, wherein
the casing includes a battery accommodating part shaped into a recess, and accommodating the battery pack,
the battery pack is accommodated in the battery accommodating part, with the uncovered portion of the battery pack facing an opening of the battery accommodating part, and
a pull-off tab is provided between the battery pack and the low adhesive sheet, the pull-off tab being attached to a face, of the battery pack, opposite a bottom face of the battery accommodating part, and extending to the uncovered portion of the battery pack.

5. The mobile device of claim 2, wherein
the casing is configured to accommodate a display panel having a back facing the battery pack, and the battery pack is accommodated in the casing, with the uncovered portion of the battery pack facing opposite the display panel.
